(19) United States
(12) Patent Application Publication
(10) Pub. No.: US 2026/0268221 A1
(43) Pub. Date: Sep. 10, 2026

(54) LEARNING SYSTEM, PREDICTION SYSTEM, AND CONTROL SYSTEM

(71) Applicant: NEC Corporation, Tokyo (JP)

(72) Inventors: Shumpei KUBOSAWA, Ibaraki (JP); Takashi Onishi, Ibaraki (JP)

(73) Assignee: NEC Corporation, Tokyo (JP)

(21) Appl. No.: 19/549,405

(22) Filed: Feb. 25, 2026

(30) Foreign Application Priority Data
Mar. 7, 2025 (JP) 2025-036335

(51) Int. Cl. G06N 20/00

(52) U.S. Cl. CPC G06N 20/00

(57) ABSTRACT

A learning system sets a mask for sensor data related to a state of a prediction target, and receives inputs of sensor data masked according to a set mask and information indicating a setting of the mask to perform training of a machine learning model that outputs a prediction value of data regarding the state of the prediction target.

### INCORPORATION BY REFERENCE

This application is based upon and claims the benefit of priority from Japanese patent application No. 2025-036335, filed on Mar. 7, 2025, the disclosure of which is incorporated herein in its entirety by reference.

### TECHNICAL FIELD

The present disclosure relates to a learning system, a prediction system, and a control system.

### BACKGROUND ART

In a case where sensor data is acquired, complete data may not be acquired.

For example, JP 2023-124200 A describes graphing sensor data that is biological information of a user measured by a sensor such as a heart rate sensor, an electrodermal activity sensor, or a skin temperature sensor, and user data collected in association with the sensor data, such as action/emotion data by user input, and user attribute data, to calculate a feature amount of the graph, and interpolating the sensor data in a loss period using the feature amount of the graph in a case where the sensor data has a loss period.

### SUMMARY

It is conceivable that the user data collected in association with the sensor data cannot be obtained depending on a target for acquiring the sensor data, such as a case where some sensors have failed at the time of plant state prediction. Even in a case where there is an abnormality in some sensor data such as a case where some sensors have failed, the state of the object for which the sensor data is acquired may be predicted without the need to collect the user data accompanying the sensor data.

An example object of the present disclosure is to provide a learning system, a prediction system, a control system, a learning method, a prediction method, a control method, and a program that can solve the above-described problems.

According to a first example aspect of the present disclosure, a learning system includes a mask setting means for setting a mask for sensor data related to a state of a prediction target, and a training processing means for receiving inputs of sensor data masked according to a set mask and information indicating a setting of the mask to perform training of a machine learning model that outputs a prediction value of data regarding the state of the prediction target.

According to a second example aspect of the present disclosure, a prediction system includes an abnormality determination means for determining presence or absence of an abnormality in sensor data by using a machine learning model trained using the sensor data related to a state of a prediction target and ground truth data indicating presence or absence of an abnormality in the sensor data, a mask setting means for setting a mask so as to mask sensor data determined to be abnormal, and a prediction means for receiving inputs of sensor data masked according to a set mask and information indicating a setting of the mask to predict the state of the prediction target using a machine learning model that outputs a prediction value related to the state of the prediction target.

According to a third example aspect of the present disclosure, a control system includes an abnormality determination means for determining presence or absence of an abnormality in sensor data by using a machine learning model trained using the sensor data related to a state of a prediction target and ground truth data indicating presence or absence of an abnormality in the sensor data, a mask setting means for setting a mask so as to mask sensor data determined to be abnormal, a prediction means for receiving inputs of sensor data masked according to a set mask and information indicating a setting of the mask to predict the state of the prediction target using a machine learning model that outputs a prediction value related to the state of the prediction target, and a control command generation means for generating a control command for the prediction target based on a prediction result of the state.

According to a fourth example aspect of the present disclosure, a learning method causing a computer to execute setting a mask for sensor data related to a state of a prediction target, and receiving inputs of sensor data masked according to a set mask and information indicating a setting of the mask to perform training of a machine learning model that outputs a prediction value of data regarding the state of the prediction target.

According to a fifth example aspect of the present disclosure, a prediction method causing a computer to execute determining presence or absence of an abnormality in sensor data by using a machine learning model trained using the sensor data related to a state of a prediction target and ground truth data indicating presence or absence of an abnormality in the sensor data, setting a mask so as to mask sensor data determined to be abnormal, and receiving inputs of sensor data masked according to a set mask and information indicating a setting of the mask to predict a state of the prediction target using a machine learning model that outputs a prediction value related to the state of the prediction target.

According to a sixth example aspect of the present disclosure, a control method causing a computer to execute determining presence or absence of an abnormality in sensor data by using a machine learning model trained using the sensor data related to a state of a prediction target and ground truth data indicating presence or absence of an abnormality in the sensor data, setting a mask so as to mask sensor data determined to be abnormal, receiving inputs of sensor data masked according to a set mask and information indicating a setting of the mask and predicting a state of the prediction target using a machine learning model that outputs a prediction value related to the state of the prediction target, and generating a control command for the prediction target based on a prediction result of the state.

According to a seventh example aspect of the present disclosure, a program for causing a computer to execute setting a mask for sensor data related to a state of a prediction target, and receiving inputs of sensor data masked according to a set mask and information indicating a setting of the mask to perform training of a machine learning model that outputs a prediction value of data regarding the state of the prediction target.

According to an aspect of the present disclosure, even in a case where there is an abnormality in some sensor data, it is possible to predict a state of a target from which sensor data is acquired without the need to collect user data accompanying the sensor data.

### BRIEF DESCRIPTION OF THE DRAWINGS

FIG. 1 is a diagram illustrating an example of a configuration of a learning system according to at least one example embodiment;

FIG. 2 is a diagram illustrating an example of data input and output in the learning system according to at least one example embodiment;

FIG. 3 is a diagram illustrating an example of a configuration of a prediction unit according to at least one example embodiment;

FIG. 4 is a diagram illustrating an example of a configuration of the prediction system according to at least one example embodiment;

FIG. 5 is a diagram illustrating an example of a configuration of a control system according to at least one example embodiment;

FIG. 6 is a diagram illustrating an example of a configuration of the learning system according to at least one example embodiment;

FIG. 7 is a diagram illustrating an example of a configuration of the prediction system according to at least one example embodiment;

FIG. 8 is a diagram illustrating an example of a configuration of the control system according to at least one example embodiment;

FIG. 9 is a diagram illustrating an example of a procedure of processing in a learning method according to at least one example embodiment;

FIG. 10 is a diagram illustrating an example of a procedure of processing in a prediction method according to at least one example embodiment;

FIG. 11 is a diagram illustrating an example of a procedure of processing in a control method according to at least one example embodiment; and

FIG. 12 is a diagram illustrating an example of a configuration of a computer according to at least one example embodiment.

### EXAMPLE EMBODIMENT

Hereinafter, example embodiments will be described with reference to the drawings.

### First Example Embodiment

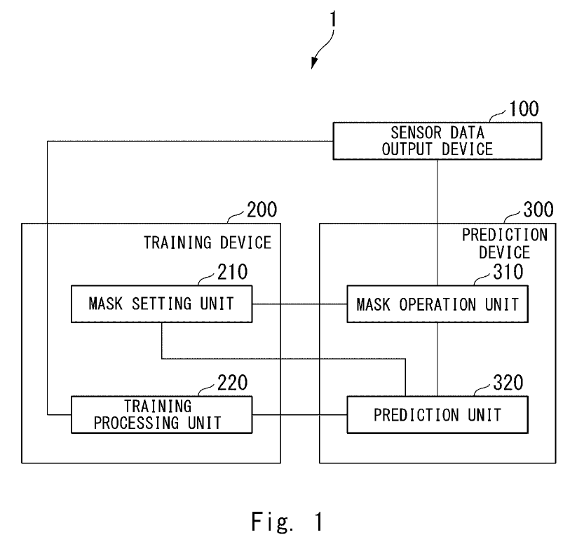

FIG. 1 is a diagram illustrating an example of a configuration of a learning system according to at least one example embodiment. In the configuration illustrated in FIG. 1, a learning system 1 includes a sensor data output device 100, a training device 200, and a prediction device 300. The training device 200 includes a mask setting unit 210 and a training processing unit 220. The prediction device 300 includes a mask operation unit 310 and a prediction unit 320.

The sensor data output device 100, the training device 200, and the prediction device 300, or a part thereof may be configured using a computer, or may be configured using an application specific integrated circuit (ASIC) or a field programmable gate array (FPGA).

The sensor data output device 100, the training device 200, and the prediction device 300, or a part thereof may be configured as one device. For example, the sensor data output device 100, the training device 200, and the prediction device 300 may be implemented in one computer.

The learning system 1 is a system for training the prediction device 300 configured to include a machine learning model. Training of the machine learning model may also be referred to as learning of the machine learning model.

The sensor data output device 100 outputs sensor data by a plurality of sensors to the training device 200 and the prediction device 300. The sensor data referred to herein is measurement data by the sensor. The sensor data can also be referred to as sensing data.

The sensor data output device 100 outputs normal sensor data indicating a value related to a state of a prediction target by the prediction device 300. The normal sensor data referred to herein is measurement data obtained by a normal sensor (a sensor in which no abnormality such as a failure occurs). The sensor data output device 100 may store and output time-series data of normal sensor data.

The learning system 1 trains the prediction device 300 using the sensor data output from the sensor data output device 100. The prediction unit 320 of the prediction device 300 includes a machine learning model, and the learning system 1 trains the machine learning model. The training of the machine learning model included in the prediction unit 320 is also referred to as training of the prediction unit 320 or training of the prediction device 300. In a case where training of the prediction unit 320 is performed, the learning system 1 masks the sensor data.

The masking of the sensor data here means applying a mask to the entire plurality of pieces of sensor data. A part of the sensor data (sensor data by a part of the plurality of sensors) is hidden from the prediction unit 320 by the mask. The entire plurality of pieces of sensor data after application of the mask is also referred to as masked sensor data.

By masking the sensor data, the learning system 1 trains the prediction unit 320 so that the prediction unit 320 can perform prediction using normal sensor data (remaining data excluding abnormal sensor data) even in a case where an abnormality occurs in some sensors.

The training device 200 sets a mask (determines a mask) for the sensor data. The training device 200 trains the prediction unit 320 using the masked sensor data.

The mask setting unit 210 sets a mask for the sensor data output from the sensor data output device 100. Specifically, the mask setting unit 210 determines whether to hide the sensor data from the prediction unit 320 for each sensor with respect to the sensor data by the plurality of sensors output from the sensor data output device 100.

The mask setting unit 210 is relevant to an example of a mask setting means.

Hiding the sensor data with respect to the prediction unit 320 is relevant to simulating the abnormality of the sensor that outputs the sensor data. As will be described later, also at the time of operation of the prediction device 300, the sensor data may be masked and abnormal sensor data may be hidden.

The mask setting unit 210 outputs the set mask to the prediction device 300.

The mask setting unit 210 may priorly set a mask for which training of the prediction unit 320 has not progressed.

For example, a policy by which the mask setting unit 210 receives an input of sensor data and outputs a mask may be trained by reinforcement learning. At that time, the mask setting unit 210 performs training of a policy using an evaluation function indicating a better evaluation as a magnitude (absolute value) of an error between a prediction value output by the prediction unit 320 in response to the input of the masked sensor data and a ground truth value (for example, unmasked sensor data (sensor data before being masked)) of the prediction value is larger.

The fact that the magnitude of the error between the prediction value output by the prediction unit 320 and the ground truth value of the prediction value is large can be regarded as that the training of the prediction unit 320 has not progressed. It is expected that the mask setting unit 210 performs training of a policy using the above evaluation function and sets a mask using the policy, thereby priorly setting a mask for which training of the prediction unit 320 has not progressed. As a result, the training of the prediction unit 320 is expected to proceed quickly.

Alternatively, the mask setting unit 210 may randomly determine the mask. That is, the mask setting unit 210 may randomly determine a sensor to be masked with sensor data.

In this case, the processing load of the mask setting unit 210 is expected to be small in that the mask is randomly determined. The learning system 1 trains the prediction device 300 using randomly masked sensor data, so that the prediction device 300 is expected to be able to perform prediction relevant to sensor abnormalities of various patterns.

The training processing unit 220 trains the prediction unit 320 using the sensor data masked according to the mask set by the mask setting unit 210. Specifically, the training processing unit 220 adjusts the parameter value of the machine learning model used by the prediction unit 320 such that the prediction value output by the prediction unit 320 in response to the input of the masked sensor data approaches the ground truth value of the prediction value.

The training processing unit 220 is relevant to an example of a training processing means.

The prediction device 300 masks the sensor data in response to inputs of the sensor data and the mask set by the mask setting unit 210. Then, the prediction device 300 outputs the prediction value related to the state of the prediction target using the masked sensor data.

The mask operation unit 310 masks the sensor data in response to inputs of the sensor data and the mask set by the mask setting unit 210.

For example, the mask operation unit 310 may output a mask indicated by a vector having an element with a value of 1 for sensor data that is not hidden by the prediction device 300 and an element with a value of 0 for sensor data that is hidden by the prediction device 300. The element of the vector can be regarded as a weight for the sensor data (a weight coefficient multiplied by the sensor data).

Then, the mask operation unit 310 may multiply the sensor data for each sensor by the element value of the mask. As a result, the value of the sensor data that is not hidden remains as the value of the sensor data input to the prediction device 300, and the value of the sensor data that is hidden becomes 0.

The mask operation unit 310 outputs the masked sensor data to the prediction unit 320.

The prediction unit 320 receives an input of the masked sensor data and the information indicating the setting of the mask, and outputs a prediction value of data related to the state of the prediction target. The information indicating the setting of the mask may be the mask itself (for example, a vector indicating a mask).

For example, the prediction unit 320 may include a neural ordinary differential equation (neural ODE), and may receive inputs of masked sensor data and information indicating the setting of the mask and output an estimated value of a time derivative of unmasked sensor data. Then, the prediction unit 320 may calculate a prediction value of the sensor data by adding an integral value of a time derivative of the sensor data to the sensor data.

However, the machine learning model included in the prediction unit 320 is not limited to a specific type of machine learning model.

As described above, the sensor data is data indicating a value related to the state of the prediction target, and the prediction value of the sensor data is relevant to the prediction value of the data related to the state of the prediction target.

For example, the sensor data may be data indicating the state of the prediction target (data specifying the state of the prediction target). In this case, the prediction value of the sensor data output by the prediction unit 320 is relevant to data for predicting the state of the prediction target. The “prediction” of the prediction value here is a prediction for a future time than the time of sensor data measurement. The prediction value of the sensor data output by the prediction unit 320 is relevant to data for predicting the state of the prediction target at a time later than the time of sensor data measurement.

The time derivative of the sensor data output from the neural ODE included in the prediction unit 320 also is relevant to the prediction value of the data related to the state of the prediction target. This time derivative can be regarded as data for predicting the change amount of the state at the time in the immediate future from the time of sensor data measurement.

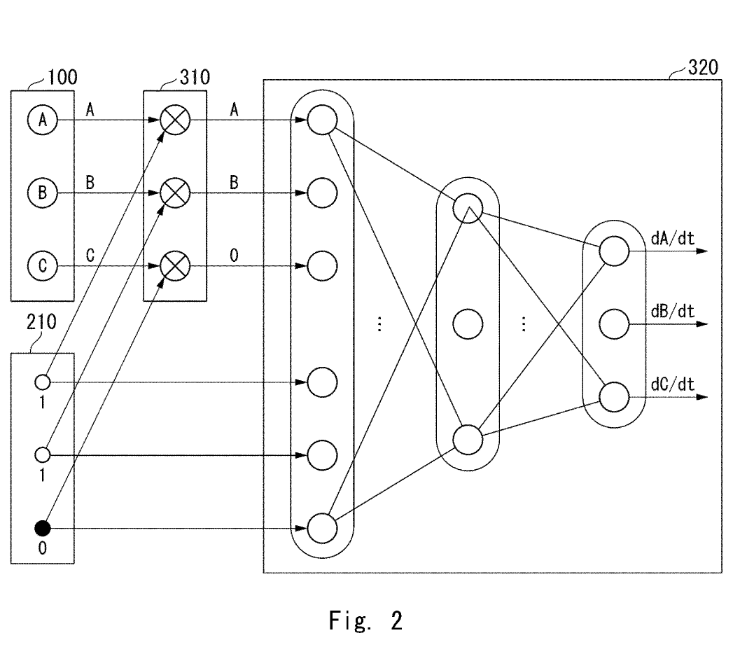

FIG. 2 is a diagram illustrating an example of data input and output in the learning system 1. FIG. 2 illustrates an example of a case where there are three sensors. The three sensors are a sensor A, a sensor B, and a sensor C. Sensor data (value of sensor data) of the sensor A is indicated by “A”, sensor data (value of sensor data) of the sensor B is indicated by “B”, and sensor data (value of sensor data) of the sensor C is indicated by “C”.

However, the number of sensors may be two or more, and is not limited to a specific number.

The sensor data output device 100 does not need to include a sensor. In FIG. 2, the sensors A, B, and C are illustrated in order to illustrate a correspondence between sensor data and a sensor.

In the example of FIG. 2, the mask setting unit 210 sets the weight of the sensor A for the sensor data to 1, sets the weight of the sensor B for the sensor data to 1, and sets the weight of the sensor C for the sensor data to 0. This weight indicates that the sensor data of the sensor A and the sensor data of the sensor B are not hidden, but the sensor data of the sensor C is hidden.

The mask operation unit 310 masks the sensor data according to the mask set by the mask setting unit 210. Regarding the values of the sensor data after masking, the value of the sensor A for the sensor data is A, the value of the sensor B for the sensor data is B, and the value of the sensor C for the sensor data is 0.

The neural ODE included in the prediction unit 320 receives inputs of the masked sensor data and the information indicating the setting of the mask, and outputs an estimated value of the time derivative dA/dt of the sensor data of the sensor A, an estimated value of the time derivative dB/dt of the sensor data of the sensor B, and an estimated value of the time derivative dC/dt of the sensor data of the sensor C. The time derivatives dA/dt, dB/dt, and dC/dt are relevant to examples of time derivatives of unmasked sensor data (sensor data before being masked).

The neural ODE included in the prediction unit 320 is a (or trained) neural network that is trained to receive inputs of masked sensor data and information indicating the setting of the mask and output an estimated value of a time derivative of unmasked sensor data. The neural ODE included in the prediction unit 320 can be referred to as an extended neural ODE that receives inputs of the masked sensor data and the information indicating the setting of the mask and outputs an estimated value of a time derivative of the unmasked sensor data.

The training processing unit 220 performs training of the neural ODE included in the prediction unit 320. For example, the training processing unit 220 may calculate the time derivative of the unmasked sensor data from the time-series data of the unmasked sensor data. Then, the training processing unit 220 may adjust the parameter value (weight between neurons, etc.) of the neural network such that the value output by the neural network (neural network used as the neural ODE) included in the prediction unit 320 in response to the input of the masked sensor data and the information indicating the setting of the mask approaches the calculated time derivative.

The prediction unit 320 may perform training of the neural network using a known learning method such as backpropagation. However, the method of training the neural network by the prediction unit 320 is not limited to a specific method.

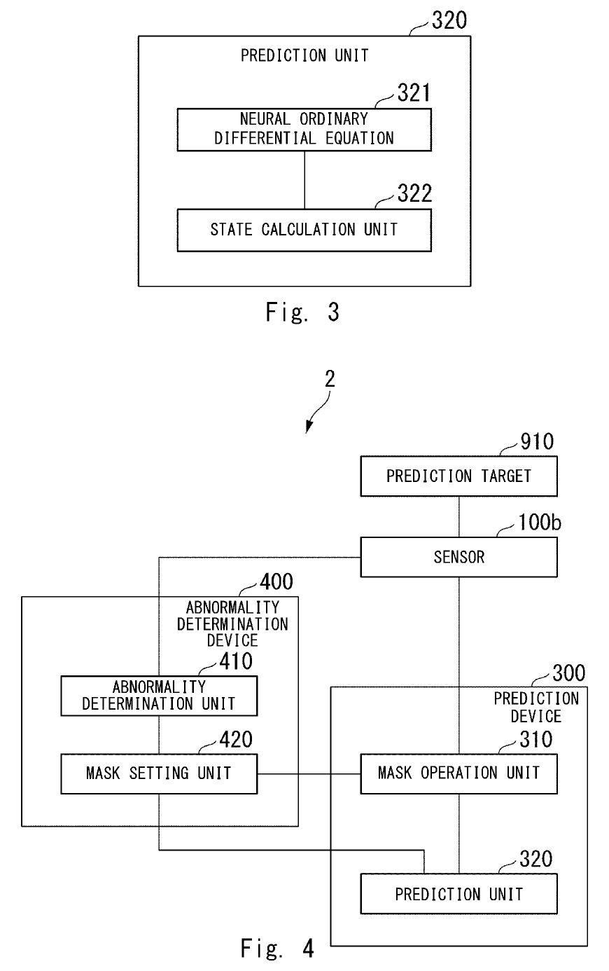

FIG. 3 is a diagram illustrating an example of a configuration of the prediction unit 320. In the configuration illustrated in FIG. 3, the prediction unit 320 includes a neural ODE 321 and a state calculation unit 322.

The neural ODE 321 receives inputs of masked sensor data and information indicating a setting of the mask, and outputs a time derivative of unmasked sensor data.

The state calculation unit 322 calculates a prediction value of the state of the prediction target using the sensor data and the time derivative calculated by the neural ODE 321.

For example, the state calculation unit 322 integrates the time derivative of the sensor data output from the neural ODE 321 to calculate the change amount of the sensor data. For example, the state calculation unit 322 may calculate the change amount in the sensor data value at a predetermined time by multiplying the time derivative of the sensor data by a predetermined time.

Then, the state calculation unit 322 calculates a prediction value of the sensor data by adding the calculated change amount to the sensor data. As described above, the prediction value of the sensor data is relevant to the prediction value of the state of the prediction target.

FIG. 4 is a diagram illustrating an example of a configuration of a prediction system according to at least one example embodiment. In the configuration illustrated in FIG. 4, a prediction system 2 includes a sensor 100b, a prediction device 300, and an abnormality determination device 400. The prediction device 300 includes a mask operation unit 310 and a prediction unit 320. The abnormality determination device 400 includes an abnormality determination unit 410 and a mask setting unit 420.

FIG. 4 illustrates a prediction target 910.

In the units of FIG. 4, the units having similar functions to those of the parts of FIG. 1 are denoted by the same reference numerals (300, 310, 320), and a detailed description thereof will be omitted here.

A control device 300 and the abnormality determination device 400, or a part thereof may be configured using a computer, or may be configured using an ASIC or an FPGA.

The control device 300 and the abnormality determination device 400, or a part thereof may be configured as one device. For example, the control device 300b and the abnormality determination device 400 may be mounted on one computer.

The control device 300b and the abnormality determination device 400, or a part thereof may be configured integrally with the prediction target 910. For example, the control device 300b and the abnormality determination device 400 may be mounted on a computer included in the prediction target 910.

The prediction target 910 is a target of state prediction by the prediction device 300. The prediction target 910 is not limited to a specific one, and may be various ones capable of measuring data regarding a state by a sensor. For example, the prediction target 910 may be a device such as a machine tool, a robot, or a mobile body (for example, a vehicle, a drone, or the like). Alternatively, the prediction target 910 may be a system including a plurality of machines, such as a chemical plant, a factory such as an iron manufacturing plant or a machine manufacturing factory, a production line in a factory, or a power plant. Alternatively, the prediction target 910 may be a natural environment such as the atmosphere, a river, or soil.

The prediction target 910 may be configured as a part of the prediction system 2 or may be a configuration outside the prediction system 2.

The sensor 100b is a combination of a plurality of sensors that measure data related to the state of the prediction target 910. The sensor 100b outputs sensor data obtained by the measurement to the prediction device 300 and the abnormality determination device 400.

The sensor 100b may be configured as a part of the prediction system 2 or may be a configuration outside the prediction system 2.

The combination of the sensor data output by all the sensors included in the sensor 100b is also referred to as a sensor data set output by the sensor 100b or simply a sensor data set.

The abnormality determination device 400 determines the presence or absence of an abnormality in the sensor data for each sensor included in the sensor 100b with respect to the sensor data set output from the sensor 100b. The abnormality determination unit 410 is relevant to an example of an abnormality determination means.

For example, the abnormality determination device 400 may include a machine learning model that receives an input of a sensor data set and outputs an estimation result of the presence or absence of abnormality of individual sensor data.

The machine learning model can be trained using, as training data, a combination of a sensor data set and teacher data indicating the presence or absence of abnormality of individual sensor data included in the sensor data set.

In the training, sensor data is input to the machine learning model, and the parameter value of the machine learning model is adjusted such that the determination result of the presence or absence of abnormality of each piece of sensor data output by the model matches or approaches the presence or absence of abnormality indicated in the teacher data.

The sensor data with abnormality in the training data may be artificially created. For example, data in which the value of the sensor data is set to a value that is not taken in a normal time or a value that is considered not to be taken in a normal time, such as setting the value of the sensor data to 0, may be used as the sensor data with abnormality. Data obtained by artificially adding noise to the sensor data may be used as sensor data with abnormality. Sensor data obtained by artificially bringing a sensor into an abnormal state, such as causing the sensor to fail, may be used as sensor data with abnormality.

The mask setting unit 420 sets a mask for the sensor data according to the determination result of the presence or absence of the abnormality of the sensor data by the abnormality determination unit 410. Specifically, the mask setting unit 420 sets a mask so as to hide, from the prediction unit 320, the sensor data determined to be abnormal by the abnormality determination unit 410 among the sensor data included in the sensor data set. The mask setting unit 420 is relevant to an example of a mask setting means.

The mask setting unit 420 outputs the set mask to the mask operation unit 310.

In the prediction system 2, a machine learning model learned by the learning system 1 is used as a machine learning model included in the prediction unit 320. The prediction unit 320 receives the inputs of the masked sensor data and the information indicating the setting of the mask using the machine learning model, and outputs the prediction value of the state of the prediction target 910.

In the prediction system 2, the mask operation unit 310 masks the sensor data set so as to hide the sensor data determined to be abnormal from the prediction unit 320. Then, the prediction unit 320 predicts the state of the prediction target 910 by using a machine learning model trained using sensor data (sensor data set) in which some sensor data is hidden.

According to the prediction system 2, in this respect, even in a case where there is an abnormality in the sensor data included in the sensor data set, it is expected that the state of the prediction target 910 can be predicted with relatively high accuracy.

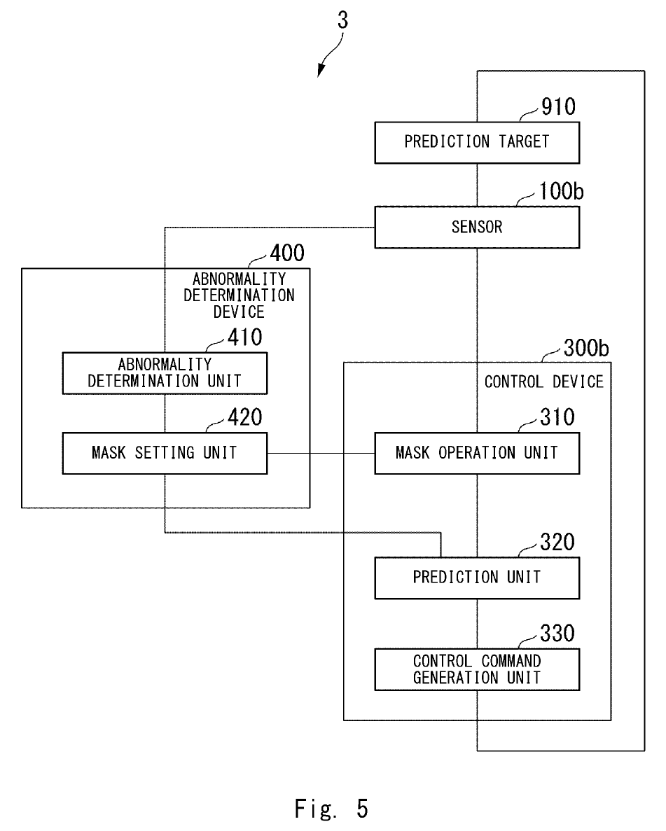

FIG. 5 is a diagram illustrating an example of a configuration of the control system according to at least one example embodiment. In the configuration illustrated in FIG. 5, a control system 3 includes a sensor 100b, a control device 300b, and an abnormality determination device 400. The control device 300b includes a mask operation unit 310, a prediction unit 320, and a control command generation unit 330. The abnormality determination device 400 includes an abnormality determination unit 410 and a mask setting unit 420.

FIG. 5 illustrates a prediction target 910.

In the units of FIG. 5, units having similar functions to those of the units of FIG. 4 are denoted by the same reference numerals (100b, 310, 320, 400, 410, 420, 910), and a detailed description thereof will be omitted here.

A control device 300b and the abnormality determination device 400, or a part thereof may be configured using a computer, or may be configured using an ASIC or an FPGA.

The control device 300b and the abnormality determination device 400, or a part thereof may be configured as one device. For example, the control device 300b and the abnormality determination device 400 may be mounted on one computer.

The control device 300b and the abnormality determination device 400, or a part thereof may be configured integrally with the prediction target 910. For example, the control device 300b and the abnormality determination device 400 may be mounted on a computer included in the prediction target 910.

In the example of FIG. 5, the prediction target 910 is a target of state prediction by the prediction unit 320, similarly to the case of FIG. 4. Furthermore, in the example of FIG. 5, the prediction target 910 is also a target to be controlled by the control device 300b.

The prediction target 910 in the example of FIG. 5 is not limited to a specific one, and can be various ones that can measure data regarding a state with a sensor and can control the prediction target 910.

For example, the prediction target 910 may be a device such as a machine tool, a robot, or a mobile body (for example, a vehicle, a drone, or the like). Alternatively, the prediction target 910 may be a system including a plurality of machines, such as a chemical plant, a factory such as an iron manufacturing plant or a machine manufacturing factory, a production line in a factory, or a power plant. Alternatively, the prediction target 910 may be a natural environment such as the atmosphere, a river, or soil.

The prediction target 910 may be configured as a part of the control system 3 or may be a configuration outside the control system 3.

The sensor 100b may also be configured as a part of the control system 3 or may be a configuration outside the control system 3.

The control device 300b is different from the prediction device 300 in including a control command generation unit 330 in addition to each unit included in the prediction device 300. Otherwise, the control device 300b is similar to the prediction device 300.

The control command generation unit 330 generates a control command for the prediction target 910 using the state prediction result by the prediction unit 320. Then, the control command generation unit 330 controls the prediction target 910 by outputting the generated control command to the prediction target 910.

For example, the control command generation unit 330 may store in advance a planned value (target value) for each time step of the state of the prediction target 910. Then, the control command generation unit 330 may generate a control command to bring the state of the prediction target 910 closer to the planned value and output (transmit) the control command to the prediction target 910. The control command generation unit 330 may perform the above control on the prediction target 910 by reinforcement learning using an evaluation function indicating better evaluation as the magnitude of the difference between the prediction value and the planned value of the state of the prediction target 910 calculated by the prediction unit 320 is smaller.

However, the method by which the control command generation unit 330 controls the prediction target 910 is not limited to a specific method, and can be various control methods performed using the prediction result of the state of the prediction target 910 by the prediction unit 320.

As in the case of the prediction system 2, the control system 3 uses the machine learning model learned by the learning system 1 as the machine learning model included in the prediction unit 320. The prediction unit 320 receives the inputs of the masked sensor data and the information indicating the setting of the mask using the machine learning model, and outputs the prediction value of the state of the prediction target 910.

In the control system 3, the mask operation unit 310 masks the sensor data set so as to hide the sensor data determined to be abnormal from the prediction unit 320. The prediction unit 320 predicts the state of the prediction target 910 by using a machine learning model trained using sensor data (sensor data set) in which some sensor data is hidden. Then, the control command generation unit 330 controls the prediction target 910 using the prediction value of the state of the prediction target 910 calculated by the prediction unit 320.

According to the control system 3, in this respect, even in a case where there is an abnormality in the sensor data included in the sensor data set, it is expected that the control for the prediction target 910 can be performed with relatively high accuracy.

As described above, the mask setting unit 210 sets a mask for the sensor data regarding the state of the prediction target.

The training processing unit 220 receives inputs of the sensor data masked according to the set mask and the information indicating the setting of the mask, and performs training of the machine learning model that outputs a prediction value of data related to the state of the prediction target.

According to the learning system 1, even in a case where there is an abnormality in some sensor data, it is possible to predict a state of the prediction target 910 (the target from which the sensor data is acquired) without the need to collect user data accompanying the sensor data.

For example, in a case where the prediction unit 320 trained in the learning system 1 is used for the prediction system 2, the prediction system 2 can predict the state of the prediction target 910 using the sensor data by the sensor 100b, and it is not necessary to collect the user data accompanying the sensor data.

In a case where the prediction unit 320 trained in the learning system 1 is used for the prediction system 2, as described above, even in a case where there is an abnormality in the sensor data included in the sensor data set, it is expected that the state of the prediction target 910 can be predicted with relatively high accuracy.

In a case where the prediction unit 320 trained in the learning system 1 is used for the control system 3, the control system 3 can predict the state of the prediction target 910 using the sensor data by the sensor 100b and control the prediction target 910, and it is not necessary to collect user data accompanying the sensor data.

In a case where the prediction unit 320 trained in the learning system 1 is used for the control system 3, as described above, even in a case where there is an abnormality in the sensor data included in the sensor data set, it is expected that the control for the prediction target 910 can be performed with relatively high accuracy.

The mask setting unit 210 sets the mask by using the policy obtained by the reinforcement learning using the evaluation function indicating the better evaluation as the magnitude of the error between the prediction value output by the machine learning model of the prediction unit 320 and the ground truth value of the prediction value is larger according to the mask output by the policy that outputs the mask in response to the input of the sensor data.

According to the learning system 1, it is expected that a mask for which training of the prediction unit 320 has not progressed may be set priorly. As a result, the training of the prediction unit 320 is expected to proceed quickly.

The mask setting unit 210 randomly sets a mask.

According to the learning system 1, the processing load of the mask setting unit 210 is expected to be small in that the mask is randomly determined. The learning system 1 trains the prediction device 300 using randomly masked sensor data, so that the prediction device 300 is expected to be able to perform prediction relevant to sensor abnormalities of various patterns.

The machine learning model of the prediction unit 320 is an extended neural ODE that receives inputs of masked sensor data and information indicating a setting of the mask and outputs an estimated value of a time derivative of unmasked sensor data.

According to the learning system 1, the state of the prediction target 910 that can continuously change in time can be predicted using the continuous time model based on the neural ODE. According to the learning system, in this respect, it is expected that the state of the prediction target 910 can be predicted with high accuracy.

Then, according to the learning system 1, even in a case where there is an abnormality in a part of the sensor data, it is expected that the state of the prediction target 910 can be predicted with high accuracy in terms of using the neural ODE extended so as to output an estimated value of a time derivative of the unmasked sensor data in response to the input of the masked sensor data and the information indicating the setting of the mask.

### Second Example Embodiment

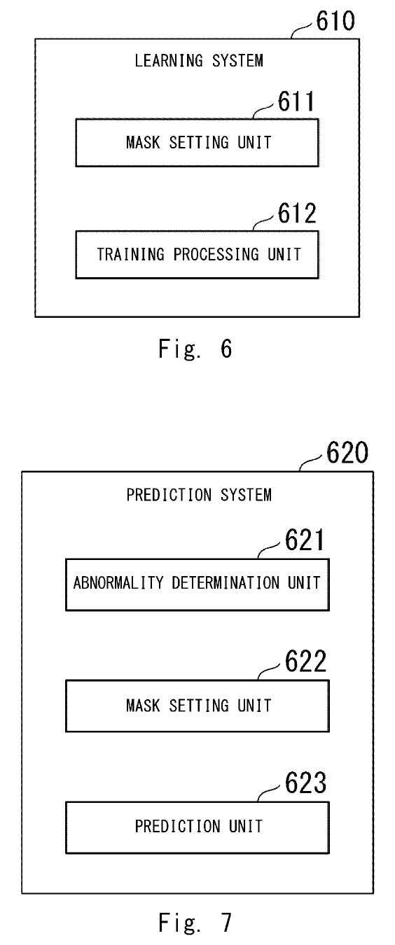

FIG. 6 is a diagram illustrating an example of a configuration of a learning system according to at least one example embodiment. In the configuration illustrated in FIG. 6, a learning system 610 includes a mask setting unit 611 and a training processing unit 612.

With this configuration, the mask setting unit 611 sets a mask for the sensor data regarding the state of the prediction target.

The training processing unit 612 receives inputs of the sensor data masked according to the set mask and the information indicating the setting of the mask, and performs training of the machine learning model that outputs a prediction value of data related to the state of the prediction target.

The mask setting unit 611 is relevant to an example of a mask setting means. The training processing unit 612 is relevant to an example of a training processing means.

According to the learning system 610, even in a case where there is an abnormality in some sensor data, it is possible to predict a state of the prediction target (the target from which the sensor data is acquired) without the need to collect user data accompanying the sensor data.

For example, in a case where a machine learning model trained in the learning system 610 is used for prediction of the state of the prediction target, the state of the prediction target can be predicted using sensor data by a sensor, and it is not necessary to collect user data accompanying the sensor data.

In a case where the machine learning model trained in the learning system 610 is used for prediction of the state of the prediction target, it is expected that the state of the prediction target can be predicted with relatively high accuracy even in a case where there is an abnormality in some sensor data.

In a case where the machine learning model trained in the learning system 610 is used for the control on the prediction target, the state of the prediction target can be predicted using the sensor data by the sensor, the control on the prediction target can be performed, and it is not necessary to collect the user data accompanying the sensor data.

In a case where the machine learning model trained in the learning system 610 is used for control on the prediction target, it is expected that control on the prediction target can be performed with relatively high accuracy even in a case where there is an abnormality in some sensor data.

The mask setting unit 611 can be implemented by using, for example, the function of the mask setting unit 210 or the like in FIG. 1. The training processing unit 612 can be implemented by using, for example, the function of the training processing unit 220 or the like in FIG. 1.

### Third Example Embodiment

FIG. 7 is a diagram illustrating an example of a configuration of a prediction system according to at least one example embodiment. In the configuration illustrated in FIG. 7, a prediction system 620 includes an abnormality determination unit 621, a mask setting unit 622, and a prediction unit 623.

With this configuration, the abnormality determination unit 621 determines the presence or absence of an abnormality in the sensor data by using the machine learning model trained using the sensor data related to the state of the prediction target and the ground truth data indicating the presence or absence of an abnormality in the sensor data.

The mask setting unit 622 sets a mask so as to mask the sensor data determined to be abnormal.

The prediction unit 623 receives the inputs of the sensor data masked according to the set mask and the information indicating the setting of the mask, and predicts the state of the prediction target using the machine learning model that outputs the prediction value related to the state of the prediction target.

The abnormality determination unit 621 is relevant to an example of an abnormality determination means. The mask setting unit 622 is relevant to an example of a mask setting means. The prediction unit 623 is relevant to an example of a prediction means.

According to the prediction system 620, even in a case where there is an abnormality in some sensor data, it is possible to predict a state of the prediction target (the target from which the sensor data is acquired) without the need to collect user data accompanying the sensor data. Specifically, according to the prediction system 620, the state of the prediction target can be predicted using the sensor data by the sensor, and it is not necessary to collect the user data accompanying the sensor data.

According to the prediction system 620, even in a case where there is an abnormality in some sensor data, it is expected that the state of the prediction target can be predicted with relatively high accuracy.

The abnormality determination unit 621 can be implemented by using, for example, a function of the abnormality determination unit 410 and the like in FIG. 4. The mask setting unit 622 can be implemented by using, for example, a function of the mask setting unit 420 or the like in FIG. 4. The prediction unit 623 can be implemented by using, for example, a function of the prediction unit 320 or the like in FIG. 4.

### Fourth Example Embodiment

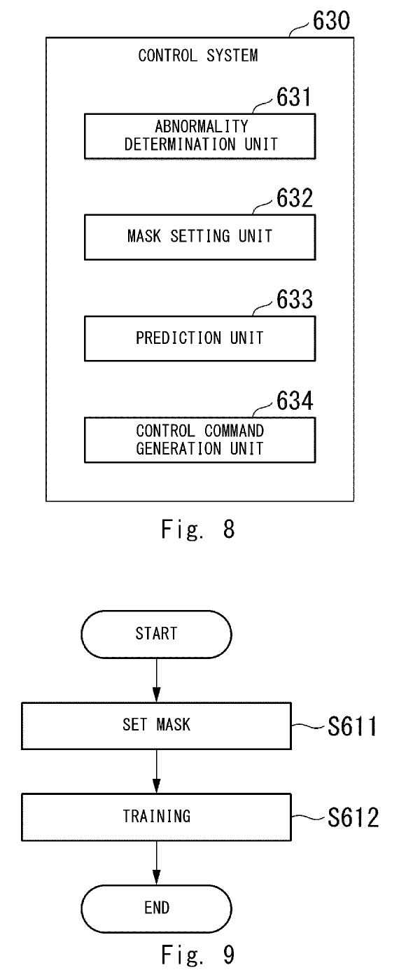

FIG. 8 is a diagram illustrating an example of a configuration of the control system according to at least one example embodiment. In the configuration illustrated in FIG. 8, a control system 630 includes an abnormality determination unit 631, a mask setting unit 632, a prediction unit 633, and a control command generation unit 634.

With this configuration, the abnormality determination unit 631 determines the presence or absence of an abnormality in the sensor data by using the machine learning model trained using the sensor data related to the state of the prediction target and the ground truth data indicating the presence or absence of an abnormality in the sensor data.

The mask setting unit 632 sets a mask so as to mask the sensor data determined to be abnormal.

The prediction unit 633 receives the inputs of the sensor data masked according to the set mask and the information indicating the setting of the mask, and predicts the state of the prediction target using the machine learning model that outputs the prediction value related to the state of the prediction target.

The control command generation unit 634 generates a control command for the prediction target based on the prediction result of the state.

The abnormality determination unit 631 is relevant to an example of an abnormality determination means. The mask setting unit 632 is relevant to an example of a mask setting means. The prediction unit 633 is relevant to an example of a prediction means. The control command generation unit 634 is relevant to an example of a control command generation means.

According to the control system 630, even in a case where there is an abnormality in some sensor data, it is possible to predict the state of the prediction target (the target from which the sensor data is acquired) and control the prediction target without the need to collect the user data accompanying the sensor data. Specifically, according to the control system 630, it is possible to predict the state of the prediction target using the sensor data by the sensor and control the control target, and it is not necessary to collect the user data accompanying the sensor data.

According to the control system 630, even in a case where there is an abnormality in some sensor data, it is expected that control for the prediction target can be performed with relatively high accuracy.

The abnormality determination unit 631 can be implemented by using, for example, a function of the abnormality determination unit 410 and the like in FIG. 5. The mask setting unit 632 can be implemented by using, for example, a function of the mask setting unit 420 or the like in FIG. 5. The prediction unit 633 can be implemented by using, for example, a function of the prediction unit 320 or the like in FIG. 5. The control command generation unit 634 can be implemented by using, for example, the function of the control command generation unit 330 or the like in FIG. 5.

### Fifth Example Embodiment

FIG. 9 is a diagram illustrating an example of a procedure of processing in a learning method according to at least one example embodiment. The learning method illustrated in FIG. 9 includes setting a mask (step S611) and performing training (step S612).

In setting the mask (step S611), the computer sets the mask for the sensor data related to the state of the prediction target.

In performing the training (step S612), the computer receives inputs of the sensor data masked according to the set mask and the information indicating the setting of the mask, and performs training of the machine learning model that outputs the prediction value of the data regarding the state of the prediction target.

According to the learning method illustrated in FIG. 9, even in a case where there is an abnormality in some sensor data, it is possible to predict a state of the prediction target (the target from which the sensor data is acquired) without the need to collect user data accompanying the sensor data.

For example, in a case where a machine learning model trained in the learning method illustrated in FIG. 9 is used for prediction of the state of the prediction target, the state of the prediction target can be predicted using sensor data by a sensor, and it is not necessary to collect user data accompanying the sensor data.

In a case where the machine learning model trained in the learning method illustrated in FIG. 9 is used for prediction of the state of the prediction target, it is expected that the state of the prediction target can be predicted with relatively high accuracy even in a case where there is an abnormality in some sensor data.

In a case where the machine learning model trained in the learning method illustrated in FIG. 9 is used for the control on the prediction target, the state of the prediction target can be predicted using the sensor data by the sensor, the control on the prediction target can be performed, and it is not necessary to collect the user data accompanying the sensor data.

In a case where the machine learning model trained in the learning method illustrated in FIG. 9 is used for control on the prediction target, it is expected that control on the prediction target can be performed with relatively high accuracy even in a case where there is an abnormality in some sensor data.

### Sixth Example Embodiment

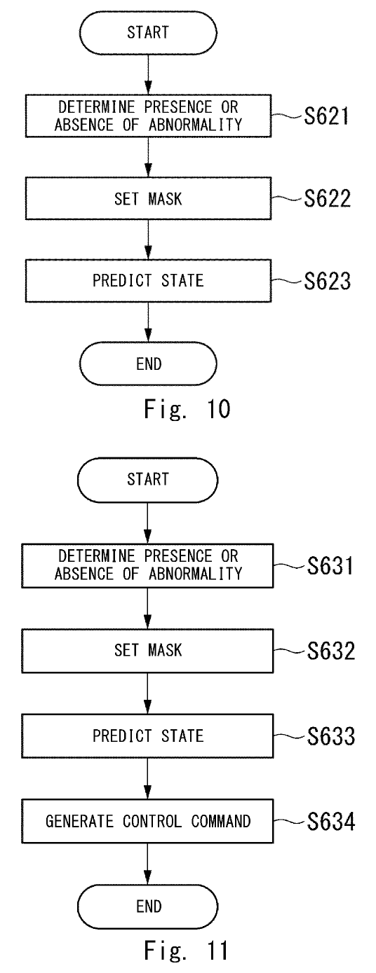

FIG. 10 is a diagram illustrating an example of a procedure of processing in a prediction method according to at least one example embodiment. The prediction method illustrated in FIG. 10 includes determining the presence or absence of an abnormality (step S621), setting a mask (step S622), and predicting a state (step S623).

In determining the presence or absence of the abnormality (step S621), the computer determines the presence or absence of the abnormality of the sensor data by using the machine learning model trained using the sensor data related to the state of the prediction target and the ground truth data indicating the presence or absence of the abnormality of the sensor data.

In setting the mask (step S622), the computer sets the mask so as to mask the sensor data determined to be abnormal.

In predicting the state (step S623), the computer receives the inputs of the sensor data masked according to the set mask and the information indicating the setting of the mask, and predicts the state of the prediction target using the machine learning model that outputs the prediction value related to the state of the prediction target.

According to the prediction method illustrated in FIG. 10, even in a case where there is an abnormality in some sensor data, it is possible to predict a state of the prediction target (the target from which the sensor data is acquired) without the need to collect user data accompanying the sensor data. Specifically, according to the prediction method illustrated in FIG. 10, the state of the prediction target can be predicted using the sensor data by the sensor, and it is not necessary to collect the user data accompanying the sensor data.

According to the prediction method illustrated in FIG. 10, even in a case where there is an abnormality in some sensor data, it is expected that the state of the prediction target can be predicted with relatively high accuracy.

### Seventh Example Embodiment

FIG. 11 is a diagram illustrating an example of a procedure of processing in a control method according to at least one example embodiment. The control method illustrated in FIG. 11 includes determining the presence or absence of an abnormality (step S631), setting a mask (step S632), predicting a state (step S633), and generating a control command (step S634).

In determining the presence or absence of the abnormality (step S631), the computer determines the presence or absence of the abnormality of the sensor data by using the machine learning model trained using the sensor data related to the state of the prediction target and the ground truth data indicating the presence or absence of the abnormality of the sensor data.

In setting the mask (step S632), the computer sets the mask so as to mask the sensor data determined to be abnormal.

In predicting the state (step S633), the computer receives the inputs of the sensor data masked according to the set mask and the information indicating the setting of the mask, and predicts the state of the prediction target using the machine learning model that outputs the prediction value related to the state of the prediction target.

In generating the control command (step S634), the computer generates the control command for the prediction target based on the prediction result of the state.

According to the control method illustrated in FIG. 11, even in a case where there is an abnormality in some sensor data, it is possible to predict the state of the prediction target (the target from which the sensor data is acquired) and control the prediction target without the need to collect the user data accompanying the sensor data. Specifically, according to the control method illustrated in FIG. 11, it is possible to predict the state of the prediction target using the sensor data by the sensor and control the control target, and it is not necessary to collect the user data accompanying the sensor data.

According to the control method illustrated in FIG. 11, even in a case where there is an abnormality in some sensor data, it is expected that control for the prediction target can be performed with relatively high accuracy.

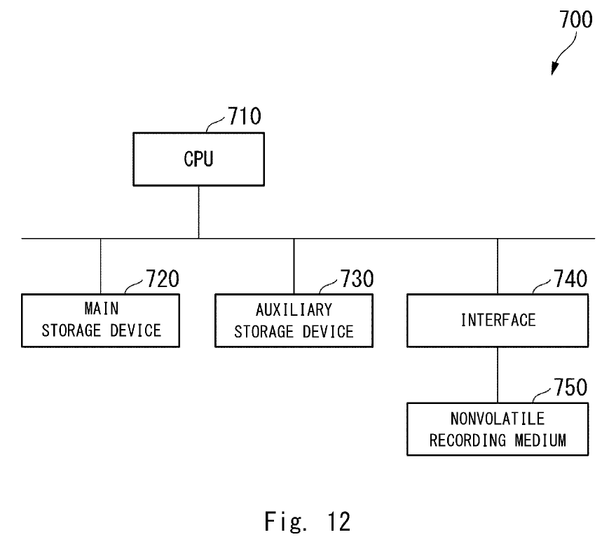

FIG. 12 is a diagram illustrating an example of a configuration of a computer according to at least one example embodiment.

In the configuration illustrated in FIG. 12, a computer 700 includes a CPU 710, a main storage device 720, an auxiliary storage device 730, an interface 740, and a nonvolatile recording medium 750.

Any one or more of the sensor data output device 100, the training device 200, the prediction device 300, the control device 300b, the abnormality determination device 400, the learning system 610, the prediction system 620, and the control system 630 described above, or a part thereof, may be implemented in the computer 700. In this case, the operation of each processing unit described above is stored in the auxiliary storage device 730 in the form of a program. The CPU 710 reads the program from the auxiliary storage device 730, loads the program in the main storage device 720, and executes the above processing according to the program. The CPU 710 secures a storage area related to each of the above-described storage units in the main storage device 720 according to the program.

Communication between each device and another device is executed by the interface 740 having a communication function and performing communication under the control of the CPU 710. The interaction between each device and the user is executed in a case where the interface 740 has an input device and an output device, information is presented to the user by the output device according to the control of the CPU 710, and a user operation is accepted by the input device. The interface 740 has a port for the nonvolatile recording medium 750, and reads information from the nonvolatile recording medium 750 and writes information to the nonvolatile recording medium 750.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

A program for executing all or part of the processing performed by the sensor data output device 100, the training device 200, the prediction device 300, the control device 300b, the abnormality determination device 400, the learning system 610, the prediction system 620, and the control system 630 may be recorded in a computer-readable recording medium, and the processing of each unit may be performed by causing a computer system to read and execute the program recorded in the recording medium. The “computer system” herein includes an operating system (OS) and hardware such as peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments may be described as the following Supplementary Notes, but are not limited to the following.

### Supplementary Note 1

A learning system including:

a mask setting means for setting a mask for sensor data related to a state of a prediction target; and

a training processing means for receiving inputs of sensor data masked according to a set mask and information indicating a setting of the mask to perform training of a machine learning model that outputs a prediction value of data regarding the state of the prediction target.

### Supplementary Note 2

The learning system according to Supplementary Note 1, in which the mask setting means sets a mask by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 3

The learning system according to Supplementary Note 1, in which the mask setting means randomly sets the mask.

### Supplementary Note 4

The learning system according to any one of Supplementary Notes 1 to 3, in which the machine learning model is a neural ordinary differential equation extended to receive inputs of masked sensor data and information indicating a setting of the mask, and output an estimated value of a time derivative of unmasked sensor data.

### Supplementary Note 5

A prediction system including:

an abnormality determination means for determining presence or absence of an abnormality in sensor data by using a machine learning model trained using the sensor data related to a state of a prediction target and ground truth data indicating presence or absence of an abnormality in the sensor data;

a mask setting means for setting a mask so as to mask sensor data determined to be abnormal; and

a prediction means for receiving inputs of sensor data masked according to a set mask and information indicating a setting of the mask to predict the state of the prediction target using a machine learning model that outputs a prediction value related to the state of the prediction target.

### Supplementary Note 6

The prediction system according to Supplementary Note 5, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 7

The prediction system according to Supplementary Note 5, in which the machine learning model is a model trained using training data obtained using a randomly set mask.

### Supplementary Note 8

The prediction system according to any one of Supplementary Notes 5 to 7, in which the machine learning model is a neural ordinary differential equation extended to receive inputs of masked sensor data and information indicating a setting of the mask, and output an estimated value of a time derivative of unmasked sensor data.

### Supplementary Note 9

A control system including:

an abnormality determination means for determining presence or absence of an abnormality in sensor data by using a machine learning model trained using the sensor data related to a state of a prediction target and ground truth data indicating presence or absence of an abnormality in the sensor data;

a mask setting means for setting a mask so as to mask sensor data determined to be abnormal;

a prediction means for receiving inputs of sensor data masked according to a set mask and information indicating a setting of the mask to predict the state of the prediction target using a machine learning model that outputs a prediction value related to the state of the prediction target; and

a control command generation means for generating a control command for the prediction target based on a prediction result of the state.

### Supplementary Note 10

The control system according to Supplementary Note 9, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 11

The control system according to Supplementary Note 9, in which the machine learning model is a model trained using training data obtained using a randomly set mask.

### Supplementary Note 12

The control system according to any one of Supplementary Notes 9 to 11, in which the machine learning model is a neural ordinary differential equation extended to receive inputs of masked sensor data and information indicating a setting of the mask, and output an estimated value of a time derivative of unmasked sensor data.

### Supplementary Note 13

A learning method causing a computer to execute:

setting a mask for sensor data related to a state of a prediction target; and

receiving inputs of sensor data masked according to a set mask and information indicating a setting of the mask to perform training of a machine learning model that outputs a prediction value of data regarding the state of the prediction target.

### Supplementary Note 14

The learning method according to Supplementary Note 13, in which in the setting of the mask, the computer executes setting a mask by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 15

The learning method according to Supplementary Note 13, in which in the setting of the mask, the computer executes randomly setting the mask.

### Supplementary Note 16

The learning method according to any one of Supplementary Notes 13 to 15, in which the machine learning model is a neural ordinary differential equation extended to receive inputs of masked sensor data and information indicating a setting of the mask, and output an estimated value of a time derivative of unmasked sensor data.

### Supplementary Note 17

A prediction method causing a computer to execute:

determining presence or absence of an abnormality in sensor data by using a machine learning model trained using the sensor data related to a state of a prediction target and ground truth data indicating presence or absence of an abnormality in the sensor data;

setting a mask so as to mask sensor data determined to be abnormal; and

receiving inputs of sensor data masked according to a set mask and information indicating a setting of the mask to predict a state of the prediction target using a machine learning model that outputs a prediction value related to the state of the prediction target.

### Supplementary Note 18

The prediction method according to Supplementary Note 17, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 19

The prediction method according to Supplementary Note 17, in which the machine learning model is a model trained using training data obtained using a randomly set mask.

### Supplementary Note 20

The prediction method according to any one of Supplementary Notes 17 to 19, in which the machine learning model is a neural ordinary differential equation extended to receive inputs of masked sensor data and information indicating a setting of the mask, and output an estimated value of a time derivative of unmasked sensor data.

### Supplementary Note 21

A control method causing a computer to execute:

determining presence or absence of an abnormality in sensor data by using a machine learning model trained using the sensor data related to a state of a prediction target and ground truth data indicating presence or absence of an abnormality in the sensor data;

setting a mask so as to mask sensor data determined to be abnormal;

receiving inputs of sensor data masked according to a set mask and information indicating a setting of the mask and predicting a state of the prediction target using a machine learning model that outputs a prediction value related to the state of the prediction target; and

generating a control command for the prediction target based on a prediction result of the state.

### Supplementary Note 22

The control method according to Supplementary Note 21, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 23

The control method according to Supplementary Note 21, in which the machine learning model is a model trained using training data obtained using a randomly set mask.

### Supplementary Note 24

The control method according to any one of Supplementary Notes 21 to 23, in which the machine learning model is a neural ordinary differential equation extended to receive inputs of masked sensor data and information indicating a setting of the mask, and output an estimated value of a time derivative of unmasked sensor data.

### Supplementary Note 25

A program for causing a computer to execute:

setting a mask for sensor data related to a state of a prediction target; and

receiving inputs of sensor data masked according to a set mask and information indicating a setting of the mask to perform training of a machine learning model that outputs a prediction value of data regarding the state of the prediction target.

### Supplementary Note 26

The program according to Supplementary Note 25, in which in the setting of the mask, the computer executes setting a mask by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 27

The program according to Supplementary Note 25, in which in the setting of the mask, the computer executes randomly setting the mask.

### Supplementary Note 28

The program according to any one of Supplementary Notes 25 to 27, in which the machine learning model is a neural ordinary differential equation extended to receive inputs of masked sensor data and information indicating a setting of the mask, and output an estimated value of a time derivative of unmasked sensor data.

### Supplementary Note 29

A program for causing a computer to execute:

determining presence or absence of an abnormality in sensor data by using a machine learning model trained using the sensor data related to a state of a prediction target and ground truth data indicating presence or absence of an abnormality in the sensor data;

setting a mask so as to mask sensor data determined to be abnormal; and

receiving inputs of sensor data masked according to a set mask and information indicating a setting of the mask to predict a state of the prediction target using a machine learning model that outputs a prediction value related to the state of the prediction target.

### Supplementary Note 30

The program according to Supplementary Note 29, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 31

The program according to Supplementary Note 29, in which the machine learning model is a model trained using training data obtained using a randomly set mask.

### Supplementary Note 32

The program according to any one of Supplementary Notes 29 to 31, in which the machine learning model is a neural ordinary differential equation extended to receive inputs of masked sensor data and information indicating a setting of the mask, and output an estimated value of a time derivative of unmasked sensor data.

### Supplementary Note 33

A program for causing a computer to execute:

determining presence or absence of an abnormality in sensor data by using a machine learning model trained using the sensor data related to a state of a prediction target and ground truth data indicating presence or absence of an abnormality in the sensor data;

setting a mask so as to mask sensor data determined to be abnormal;

receiving inputs of sensor data masked according to a set mask and information indicating a setting of the mask and predicting a state of the prediction target using a machine learning model that outputs a prediction value related to the state of the prediction target; and

generating a control command for the prediction target based on a prediction result of the state.

### Supplementary Note 34

The program according to Supplementary Note 33, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

### Supplementary Note 35

The program according to Supplementary Note 33, in which the machine learning model is a model trained using training data obtained using a randomly set mask.

### Supplementary Note 36

The program according to any one of Supplementary Notes 33 to 35, in which the machine learning model is a neural ordinary differential equation extended to receive inputs of masked sensor data and information indicating a setting of the mask, and output an estimated value of a time derivative of unmasked sensor data.

1. A learning system comprising:
at least one memory configured to store instructions; and
at least one processor configured to execute the instructions to:
set a mask for sensor data related to a state of a prediction target; and
receive inputs of sensor data masked according to a set mask and information indicating a setting of the mask to perform training of a machine learning model that outputs a prediction value of data regarding the state of the prediction target.

2. The learning system according to claim 1, wherein the at least one processor is further configured to execute the instructions to set a mask by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

3. The learning system according to claim 1, wherein the at least one processor is further configured to execute the instructions to randomly set the mask.

4. The learning system according to claim 1, wherein the machine learning model is a neural ordinary differential equation extended to receive inputs of masked sensor data and information indicating a setting of the mask, and output an estimated value of a time derivative of unmasked sensor data.

5. A prediction system comprising:
at least one memory configured to store instructions; and
at least one processor configured to execute the instructions to:
determine presence or absence of an abnormality in sensor data by using a machine learning model trained using the sensor data related to a state of a prediction target and ground truth data indicating presence or absence of an abnormality in the sensor data;
set a mask so as to mask sensor data determined to be abnormal; and
receive inputs of sensor data masked according to a set mask and information indicating a setting of the mask to predict the state of the prediction target using a machine learning model that outputs a prediction value related to the state of the prediction target.

6. The prediction system according to claim 5, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

7. The prediction system according to claim 5, in which the machine learning model is a model trained using training data obtained using a randomly set mask.

8. The prediction system according to claim 5, in which the machine learning model is a neural ordinary differential equation extended to receive inputs of masked sensor data and information indicating a setting of the mask, and output an estimated value of a time derivative of unmasked sensor data.

9. A control system comprising:
at least one memory configured to store instructions; and
at least one processor configured to execute the instructions to:
determine presence or absence of an abnormality in sensor data by using a machine learning model trained using the sensor data related to a state of a prediction target and ground truth data indicating presence or absence of an abnormality in the sensor data;
set a mask so as to mask sensor data determined to be abnormal;
receive inputs of sensor data masked according to a set mask and information indicating a setting of the mask to predict the state of the prediction target using a machine learning model that outputs a prediction value related to the state of the prediction target; and
generate a control command for the prediction target based on a prediction result of the state.

10. The control system according to claim 9, in which the machine learning model is a model trained using training data obtained using a mask which is set by using a policy obtained by reinforcement learning using an evaluation function indicating a better evaluation as a magnitude of an error between a prediction value output from the machine learning model according to the mask output by a policy that outputs the mask in response to an input of sensor data and a ground truth value of the prediction value is larger.

11. The control system according to claim 9, in which the machine learning model is a model trained using training data obtained using a randomly set mask.

12. The control system according to claim 9, in which the machine learning model is a neural ordinary differential equation extended to receive inputs of masked sensor data and information indicating a setting of the mask, and output an estimated value of a time derivative of unmasked sensor data.
